(19) United States
(12) Patent Application Publication
(10) Pub. No.: US 2007/0178424 A1
(43) Pub. Date: Aug. 2, 2007

(54) Manual dental instrument, dental care unit and method for displaying data using a manual dental instrument

(76) Inventor: Matthias Rein, Lorsch (DE)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/588,653

(22) PCT Filed: Feb. 10, 2005
(86) PCT No.: PCT/EP05/50600

§ 371 Date: Aug. 7, 2006

(30) Foreign Application Priority Data
Feb. 11, 2004 (DE) 10 2004 006 805.4

(51) Int. Cl. A61C 1/00

(52) U.S. Cl. 433/29

(57) ABSTRACT

The invention concerns a manual dental instrument equipped with an illuminating device (30, 34) for illuminating a site on a tooth to be examined or treated using a spotlight cone (18). Said manual instrument comprises devices (30, 36) for mixing a coloured light with the spotlight cone (18) to display supplementary data intended for the user of the manual instrument (10). Moreover, a dental care device provided in the manual instrument comprises luminous devices (30, 36) for mixing a coloured light, said luminous devices (30, 36) being controlled by a control unit and an analyzing unit processing the data of the sensor in co-operation with the control unit, such that the user of the manual instrument (10), through the mixture of coloured light with the spotlight cone (9) receives by display data concerning the property of the surface of the tooth to be treated. The invention also concerns a method for displaying at least one property of the tooth to be treated intended for the user of said manual dental instrument. Said method is characterized in that the display devices controlled by the sensor-actuated control devices display to the user the property of the surface of the tooth to be treated, a coloured light being mixed with the spotlight cone (18) of the illuminating device (30, 34) and the luminous devices (30, 36) used as display devices.

### TECHNICAL FIELD

The invention relates to a dental hand instrument comprising an illuminating device for illuminating, by means of a spotlight cone, a site to be examined or treated.

The invention further relates to a dental treatment center comprising a sensor for detecting at least one property of a tooth surface to be treated, an evaluation unit, a control unit, and a hand instrument. The hand instrument is equipped with an illuminating device for illuminating, by means of a spotlight cone, a site to be examined or treated.

In addition, the invention relates to a method for displaying at least one property of a tooth surface to be treated for observation by a user of a dental hand instrument equipped with an illuminating device for illuminating, by means of a spotlight cone, the site to be treated, the property of the tooth surface to be treated being detected by a sensor, the signal from the sensor being evaluated by an evaluation unit, and the evaluated signal being transmitted to a control unit. The control unit controls the display means, which indicate to the user the property of the tooth surface to be treated.

### DESCRIPTION OF THE RELATED ART

In such hand instruments, there is often the need to display additional information in the dentist's field of vision. For example, it would be desirable, when using a dental instrument, for there to be an indication of the presence or absence of caries on the site to be treated. Such an indication is typically produced by the use of diodes attached at the proximal end of the handpiece. Furthermore, caries indicators known from the prior art are attached to the tabletop unit and additionally produce an acoustic signal. In addition to caries displays, there are also instruments available on the market which comprise displays for indicating the presence of tartar.

DE 195 20 7 65 A1 discloses hand instruments, by means of which a length measurement, for example for root canal preparation, can be carried out, or in which the battery charge state is displayed.

However, this suffers from the drawback that the visibility of the display depends on the position of the handpiece. If the handpiece is positioned awkwardly, the diodes may be hidden and thus out of sight of the user. In addition, such diodes make it difficult to clean and disinfect the handpiece and are therefore considered to be unhygienic.

In another known embodiment, the additional information is indicated by an acoustic signal produced within the dental hand instrument. However, such acoustic signals may divert the dentist's attention and often subject him to stress. The patients also usually feel disturbed and bothered by the beeps.

This forms the basis of the present invention. The object of the invention, as characterized in the claims, is to develop a hand instrument of this type so as to enable an ergonomic display of additional information for the user of a single hand instrument adapted for diagnosis and treatment. The invention also enables the user to switch from diagnosis mode to treatment mode.

### SUMMARY AND OBJECTS OF THE INVENTION

This object is achieved according to the invention by the dental hand instrument as defined in claim 1, a dental treatment center as defined in claim 11, and a method as defined in claim 16 for indicating at least one property of a tooth surface to be treated. Preferred embodiments of the invention form the subject matter of the dependent claims.

According to a first aspect of the invention, in a hand instrument of the type mentioned above, means are provided for adding colored light to the spotlight cone for displaying additional information to a user of the hand instrument.

Thus in this aspect, the invention is based on the idea of displaying the additional information at the site on which the user's attention is already concentrated, namely on that part of the tooth which is illuminated by the spotlight cone. Such a display can serve, for example, as an indication of the existence of caries. In addition, the invention can also be applied to a device which is suitable for carrying out treatment in addition to ascertaining and evaluating the state of the tooth. In such a case, means for switching between the two modes of operation should likewise be integrated so as to enable the user to switch over to the treatment mode after or during the evaluation of the state of the tooth.

In a preferred embodiment, said means comprise illuminants and a control unit, which controls the addition of colored light to the spotlight cone. The control unit is adapted to react to external parameters and controls the addition of colored light in a specific manner.

It is particularly advantageous for the hand instrument to have a sensor for detecting at least one property of the site of the tooth to be treated and for the output signal thereof to be sent to the control unit. The control unit can then add an appropriate color as determined by the output signal.

The addition of colored light to the basic light can be clearly noticed by the user if sufficiently bright illuminants are used, thus making it possible to provide him with the additional information in an ergonomical manner. For example, teeth, as well as the surrounding mouth cavity and throat cavity, reflect the incident light and make its color clearly visible to the user. The patient can hardly notice, if at all, the change of color and is thus neither disturbed nor bothered thereby.

The illuminating device is preferably formed by a light source emitting a white light, especially a white light-emitting diode. The addition of colored light for imparting information is then particularly easy to carry out. Instead of a light-emitting diode, other illuminating means having a comparable function can be used, if desired, to which the following description will apply accordingly.

In a preferred embodiment of the hand instrument of the invention, the means for adding colored light comprise at least one colored light-emitting diode. Even when using only one color, different items of information can be indicated by varying the intensity of the added color. Another way of indicating different information or of increasing the amount of presentable information consists in providing a plurality of light-emitting diodes of various colors.

In another preferred embodiment of the hand instrument of the invention, a multi-colored light-emitting diode can be provided, which, in a first mode of operation, emits white light for illuminating the site of the tooth to be examined or treated, and which, in a second mode of operation, emits light to which colored light has been added for displaying additional information in relation to the first mode of operation. In this embodiment, only one light-emitting component is required, which both illuminates the site of the tooth to be examined or treated and performs the function of imparting information. This allows for a simple and disturbance insensitive design of the hand device of the invention.

In the above context, it is advantageous to design and adapt said means such that the colored light is added homogeneously to the spotlight cone.

In another embodiment, said means may be designed and adapted so as to add the colored light only to a locally restricted region of the spotlight cone. While the first solution allows for a particularly simple design of the hand instrument, the latter embodiment makes it possible to illuminate the site to be examined or treated with non-colored light, i.e. with white light or whitish light and to display the color-coded additional information in its immediate vicinity, namely inside the spotlight cone.

The hand instrument of the invention advantageously comprises a housing with a handpiece, at the distal end of which the spotlight cone is emitted. The handpiece preferably contains an optical fiber, which guides the illuminating light and the colored light for displaying additional information to the distal end of the handpiece.

Another aspect of the invention relates to a dental treatment center, in which illuminants for adding colored light are provided in the hand instrument, said illuminants being controlled by the control unit. The evaluation unit processes information coming from the sensor and cooperates with the control unit in such a way that information concerning the property of the tooth surface to be treated is displayed to a user of the hand instrument in that colored light is added to the spotlight cone. Such a treatment unit enables the recognition, display and, if the hand instrument is equipped with a tool, the treatment of the relevant diseased part of the tooth. A change of the illumination color will then indicate to the user that the diseased tissue has been removed completely.

An advantageous development of the dental treatment center relates to the accommodation of the sensor in a hand instrument. This makes it possible to detect the site which is to be treated. In addition, it is distinctly simpler to work with such a dental treatment center as compared with a dental treatment center having a separate sensor.

The control unit is advantageously accommodated in the hand instrument. It is thus possible to provide additional operating elements on the hand instrument which cause the control unit to add variably colored light depending on the requirements of the user.

Another preferred embodiment relates to a dental treatment center, in which the evaluation unit is accommodated in the hand instrument. This enables a compact design and simple handling of the dental treatment center.

The control unit is advantageously designed in such a way that if subregions not requiring treatment are detected within the region of the tooth surface that does require treatment, said control unit activates the illuminants so as to add a light that is differently colored from the light used when detecting regions of the tooth surface still requiring treatment.

Another aspect of the invention relates to a method for displaying at least one property of a tooth surface to be treated to a user of a dental hand instrument. In the method of the invention, colored light is added to the spotlight cone of the illuminating device of the hand instrument by using illuminants as display means for the property of the tooth surface to be treated. Such display means are, on the one hand, cheap and, on the other hand, if arranged appropriately, readily perceptible by the user of the dental hand instrument.

The spotlight cone advantageously remains unchanged as long as no property of the tooth surface to be treated is detected. This can be the case, for example, if the sensor for detecting the property of the tooth surface cannot produce a detection signal, such as when a contact sensor makes no contact.

Advantageously a first color is added to the spotlight cone when detecting regions of the tooth surface to be treated that do not require treatment.

It is particularly advantageous to add a second color, which can be easily distinguished from the first color, to the spotlight cone when detecting regions of the tooth surface to be treated that do require treatment. The user can thus precisely distinguish between regions that require treatment and those that do not.

It is especially advantageous to add the colored light only in a subregion of the spotlight cone. This enables the actual treatment area to be illuminated by light that is uncolored as far as possible, while displaying the state of the tooth surface to be treated in an outer area of the spotlight cone, said outer area being easily perceptible by the user.

Additional preferred embodiments, features, and details of the invention are specified in the dependent claims, in the description of the exemplary embodiments, and in the drawings.

### BRIEF DESCRIPTION OF THE DRAWINGS

The invention is explained in more detail below with reference to an exemplary embodiment in conjunction with the drawings. Only those elements which are essential for understanding the invention are shown in the drawings, in which:

FIG. 1 is a perspective view of an exemplary embodiment of a dental hand instrument according to a first aspect of the invention, illustrated as used during an examination;

FIG. 2 is a diagrammatic illustration of a cross section of an exemplary embodiment of a medical or dental hand instrument according to the first aspect of the invention;

FIGS. 3a and 3b are each diagrammatic illustrations of the illuminating device in the hand instrument shown in FIG. 1, said illuminating device being enlarged to provide detailed information;

FIG. 4 is a diagrammatic illustration of an exemplary embodiment of a medical or dental hand instrument according to the second aspect of the invention;

FIG. 5 is a diagrammatic illustration of a detail of another exemplary embodiment of a hand instrument according to the second aspect of the invention; and

FIG. 6 is a perspective view of a dental treatment center, illustrated as used during an examination.

### DETAILED DESCRIPTION OF EXEMPLARY EMBODIMENTS OF THE INVENTION

FIG. 1 is a perspective view of a dental hand instrument, indicated in general by the reference numeral 10, according to one exemplary embodiment of the invention, as used during examination of the teeth 20 of a patient.

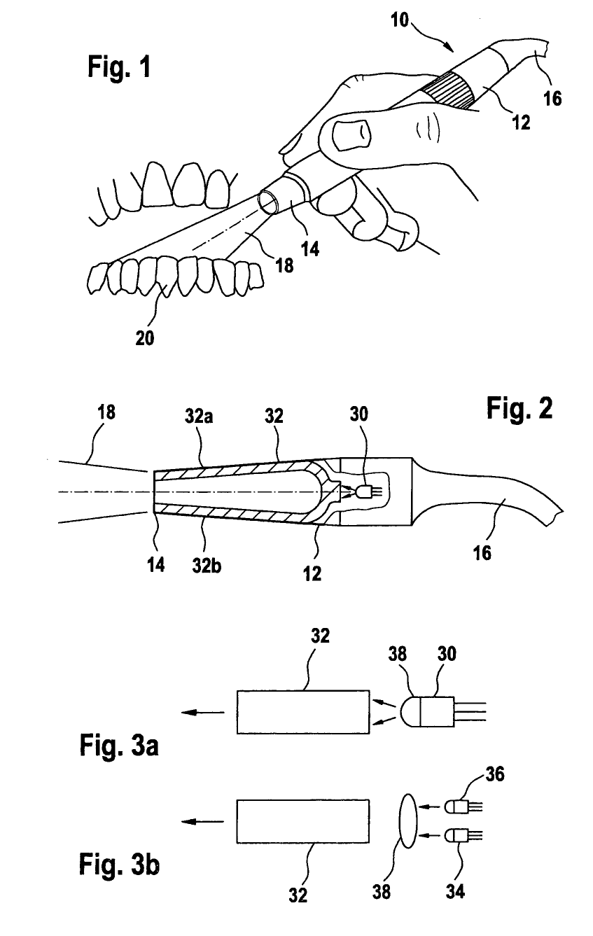

The hand instrument 10 comprises a long handpiece 12, in which a multi-colored light-emitting diode 30 (FIG. 2) for illuminating the site to be examined, is integrated. The light-emitting diode 30, as described in more detail below, emits white light or colored light, which is emitted from the distal end 14 of the handpiece as a spotlight cone 18. At its proximal end, the handpiece 12 is connected to a flexible pipe 16, in which, for example, electrical conductors and conduits for compressed air, water, and the like are accommodated.

The cross section shown in FIG. 2 illustrates diagrammatically the manner in which the illumination of the multi-colored light-emitting diode 30 is launched into the optical fiber 32, which guides the illumination to the distal end 14 of the handpiece 12, where it is emitted as the spotlight cone 18. The light-emitting diode 30 fulfils two functions. In a first mode of operation, in which the light-emitting diode 30 emits white light or whitish light, it serves exclusively for illuminating the site to be examined. In a second mode of operation, colored light is added to the white light, for providing the dentist with additional information in an ergonomic manner.

For example, red light can be added to the white light for indicating the existence of caries on the site to be treated. The addition of green light can indicate that the site to be treated is free from caries. In the arrangement of the exemplary embodiment of FIG. 2, the colored light is added homogeneously to the white light, i.e. it is added uniformly over the entire spotlight cone 18. However, the color addition can be alternatively effected over only a portion of the spotlight cone 18. For example, the colored light 32 can be added only to the upper half 32a of the optical fiber 32, while pure white light is launched into the lower half 32b.

In (a) and (b) of FIG. 3 there are shown two variants for realizing the addition of colored light. Variant (a) is realized in the hand instrument shown in FIG. 2, where a multi-colored light-emitting diode 30 not only illuminates the site to be examined, but also serves to indicate additional information by the addition of colored light. The light-emitting diode 30 can be provided, as shown in FIG. 3(a), with a convex lens 38 for concentrating the emitted illumination and for launching it into the optical fiber 32.

Two separate light-emitting diodes 34 and 36 are provided in the variant shown in FIG. 3(b). The white light-emitting diode 34 carries out the regular illumination of the site to be examined, whilst the red light-emitting diode 36 is provided for displaying the additional information. Of course, a differently colored light-emitting diode or a plurality of differently colored light-emitting diodes can be used instead of the red light-emitting diode 36. In this variant, a convex lens 38 can again be provided for concentrating the illumination.

The information can be coded not only by the color of the added illumination, but also by its intensity.

Since both the teeth 20 and the surrounding mouth cavity or the throat cavity of the patient reflect the incident light, the dentist can easily recognize any change in color or any change in brightness of the added colored light. The additional coded information lies directly in his line of vision or field of focus and thus at the center of his attention. At the same time this does not disturb or bother the patient.

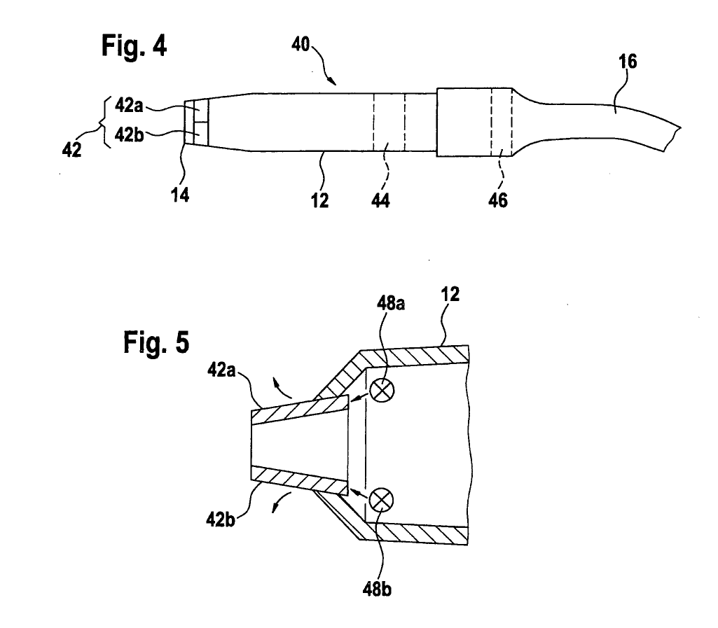

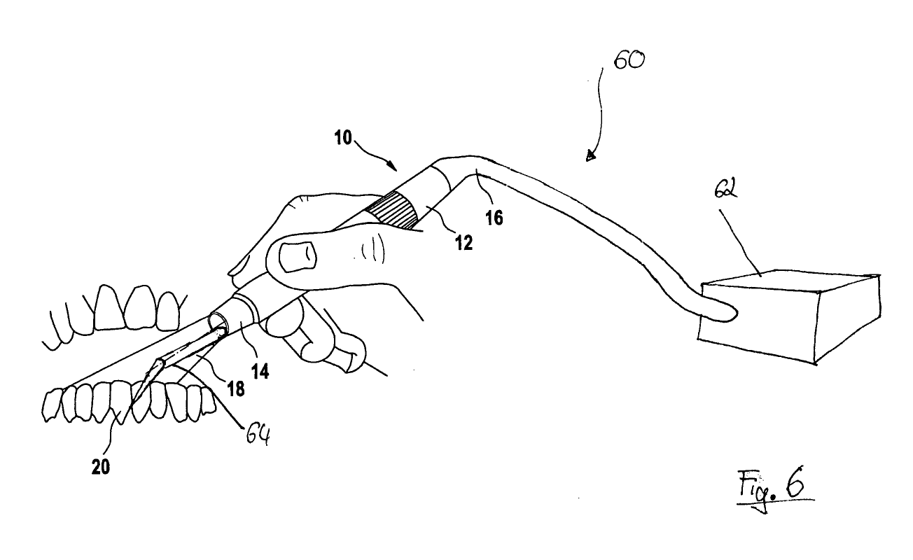

FIG. 4 shows a diagrammatic illustration of an exemplary embodiment of a dental hand instrument 40 according to a second aspect of the invention. Here, the additional information is not coded in the spotlight cone 18, but rather indicated by an illuminated ring 42 disposed at the distal end 14 of the handpiece 12. The illuminated ring 42 comprises two segments 42a and 42b, which serve for indicating different items of information. As illustrated in the cross section shown in FIG. 5, for example, the segment 42a can be illuminated by a red light source 48a, whilst the segment 42b is illuminated by a green light source 48b. Due to its locality, the illuminated ring 42 lies almost directly in the line of vision or field of focus of the dentist, as a result of which the additional information displayed can be easily recognized by the user.

The illuminated rings 44 (disposed nearer the proximal end of the handpiece 12) and 46 (disposed on the pipe 16), indicated by dashed lines, illustrate additional possibilities for placing the illuminated ring on the housing of the hand instrument 40. In both cases, the illuminated rings are indirectly in the field of vision, but not in the field of focus, of the user. However, the dentist can recognize and perceive the indicated color information in the corner of his eye. The illuminated rings 44 and 46 can also be divided into segments.

In an extreme case, an illuminated ring can include the entire housing of the hand instrument. In this case, the entire housing is illuminated for displaying the information. This can be realized, for example, by the use of a sheath of transparent, sterilizable material, especially a plastics material suitable for this purpose or by using an illuminable sterilizable material embedded in the outer shell, this being possible by using, say, injected glass fibers.

An exemplary embodiment according to the second aspect of the invention is illustrated diagrammatically in FIG. 6. The dental treatment center 60 substantially comprises the hand instrument 10 and the evaluation unit 62. On the dental hand instrument 10, a scaler tip 64 is provided, which on the one hand serves for removing carious regions of a tooth surface being treated and on the other hand represents the probe for the sensor (not shown) that serves for detecting the property of the tooth surface. The dental hand instrument 10 is additionally connected via a flexible pipe 16 to the evaluation unit 62, which in addition provides the hand instrument with all the media required for treatment.

When the scaler tip 64 slides over a diseased portion of the tooth, the resulting change in vibration behavior of the scaler tip 64 causes a different evaluation signal to be produced in the sensor. The evaluation signal from the sensor is processed in the evaluation unit 62, which, on the basis of various algorithms, detects the relevant part of the tooth 20 as being the diseased part. The evaluation unit 62 consequently transmits corresponding signals to the control unit, which controls the addition of colored light to the spotlight cone 18. The arrangement of the different components required for evaluating a signal produced by the sensor is on the whole of secondary importance.

Alternatively, the evaluation unit 62 can be directly integrated in the handpiece 12 or the evaluation unit 62 can form a component of a dental treatment center.

Another feature of a structural embodiment can be an element that can be stimulated to effect vibration, for example, an element made of piezo ceramics, which is attached to the grip area of the hand instrument 10 and which gives information to the user with the help of appropriate signals either individually or in combination with an optical display. This element can be placed in the same position as the evaluation unit 62 in FIG. 6. It can comprise one or more vibration elements or a circumferential ring capable of vibrating.

1. A dental hand instrument (10) equipped with an illuminating device (30; 34) for illumination, by means of a spotlight cone (18), of a site on a tooth (2) to be examined or treated, including means (30; 36) for mixing colored light to said spotlight cone (18) for indicating additional information to an operator of said hand instrument (10) by causing a change of color.

2. A dental hand instrument as defined in claim 1, wherein said means (30; 36) consist of illuminants and a control unit, and said control unit controls the addition of colored light to said spotlight cone (18).

3. A dental instrument as defined in claim 1, wherein said hand instrument (10) is equipped with a sensor for detecting at least one property of the site of the tooth (20) to be treated and an output signal thereof is sent to said control unit.

4. A dental hand instrument as defined in claim 1, wherein said illuminating unit (30; 34) is formed by a white light-emitting light source (34).

5. A dental hand instrument as defined in claim 1, wherein said means (30; 36) for adding colored light comprise at least one colored light-emitting diode (36).

6. A dental hand instrument as defined in claim 1, wherein a multicolored light-emitting diode (30) is provided which, in a first mode of operation, emits white light for illumination of the site to be examined or treated of said tooth (20), and, in a second mode of operation, emits light to which colored light has been added to indicate information additional to that indicated in the first mode of operation.

7. A dental hand instrument as defined in claim 1, wherein said means (30; 36) are designed and adapted to achieve homogeneous addition of colored light to said spotlight cone (18).

8. A dental hand instrument as defined in claim 1, wherein said means (30; 36) are designed and adapted to achieve locally restricted addition of colored light to said spotlight cone (18).

9. A dental hand instrument as defined in claim 1, wherein said hand instrument (10) has a housing having a handpiece (12), at the distal end (14) of which said spotlight cone (18) is emitted.

10. A dental hand instrument as defined in claim 9, wherein said handpiece (12) contains an optical fiber (32), which guides the illuminating light and the colored light to the distal end (14) of said handpiece (12) for indication of additional information.

11. A dental treatment center, comprising a sensor for detecting at least one property of a surface of the tooth to be treated, an evaluation unit (62), a control unit, and a hand instrument (10), said hand instrument (10) being equipped with an illuminating unit (30; 34) for illumination, by a spotlight cone (18), of a site to be examined or treated, including in said hand instrument (10) illuminants (30; 36) for the purpose of adding colored light, said illuminants (30; 36) being controlled by said control unit and said evaluation unit (62) processing information from said sensor and cooperating with said control unit in such a manner that a user of said hand instrument (10) will receive information on the property of the surface of the tooth to be treated by in that colored light is added to the spotlight cone (18).

12. A dental treatment center as defined in claim 11, wherein said sensor is accommodated in said hand instrument (10).

13. A dental treatment center as defined in claim 11, wherein said control unit is accommodated in said hand instrument (10).

14. A dental treatment center as defined in claim 11, wherein said evaluation unit (62) is accommodated in said hand instrument (10).

15. A dental treatment center as defined in claim 11, wherein when subregions have been detected which are not in need of treatment within a region of the surface of the tooth which does require treatment, said control unit controls said illuminants (30; 36) so as to add a light which is differently colored from that indicating the regions of the surface of the tooth which are still in need of treatment.

16. A method for indicating at least one property of a surface of the tooth to be treated to a user of a dental hand instrument equipped with an illuminating unit (30; 34) for illumination, by means of a spotlight cone (18), of the site to be treated, the property of the surface of the tooth to be treated being detected by means of a sensor, the signal from the sensor being evaluated by means of an evaluation unit (62), and the evaluated signal being sent to a control unit which controls display means indicating to the user the property of the surface of the tooth to be treated, wherein colored light is added to said spotlight cone (18) of said illuminating unit (30; 34) by the use of illuminants (30; 36) as display means.

17. A method as defined in claim 16, wherein said spotlight cone (18) remains unchanged as long as no property of the surface of the tooth to be treated is recognized.

18. A method as defined in claim 16, wherein when regions of the surface of the tooth to be treated which are not in need of treatment are detected, a first color is added to said spotlight cone (18).

19. A method as defined in claim 16, wherein when regions of the surface of the tooth to be treated that require treatment are detected, a second color is added to the spotlight cone (18) which is distinguishable from said first color.

20. A method as defined in claim 16, wherein the addition of colored light is only carried out in a subregion of said spotlight cone (18).
